(19) United States
(12) Patent Application Publication
(10) Pub. No.: US 2011/0309636 A1
(43) Pub. Date: Dec. 22, 2011

(54) URGENCY GENERATOR AND MACHINE CHARGING SYSTEM

(76) Inventor: Rassoul Mollaie, Vavan City (IR)

(21) Appl. No.: 12/894,029

(22) Filed: Sep. 29, 2010

(30) Foreign Application Priority Data
Sep. 28, 2009 (IR) 61211

(51) Int. Cl. F03G 5/06

(52) U.S. Cl. 290/1 C

(57) ABSTRACT

A generator is disclosed herein for pedaling to produce power. The generator comprises a frame comprising metallic parts, a first belt; and a box, wherein the generator receives concurrent pressure for starting a main dynamo.

### CROSS-REFERENCE TO RELATED APPLICATIONS

The present invention claims priority of Iranian Patent Application Number 61211, filed on Sep. 29, 2009, which is incorporated herein by reference in its entirety.

### BACKGROUND OF THE INVENTION

This invention relates to a generator, which is generally used under urgency circumstances, to produce power by pedaling.

The generator and urgent electrical sets currently available require an energy supplier such as batteries or fuel products. If the user does not charge them or prepare fuel supplies by the time he or she uses those conventional generators, the generators will not function or malfunction during the time of use.

### SUMMARY OF THE INVENTION

Given the above deficiencies of prior art, there is a need for a generator which does not require “preparation” such as pre-charging by the time of emergency. This invention disclosed herein achieves this goal to produce power by way of human acts, e.g., pedaling.

The innovative generator continues to produce power by pedaling continuously.

One advantage of this present invention in comparison to conventional generators is that it can do without battery or fuel supplies such as petrol etc. Therefore, the present invention is highly desirable, especially in remote areas where is more difficult to transport fuel thereto.

Another advantage of the innovative generator as reflected in its framework and physical structure design is that the generator allows one person or more to pedal concurrently or independently. The pedaling required can be intermittent, yet constantly produces power for a certain period of time.

In some embodiments, the present invention is connected to a battery charger. For instance, with an hour of consecutive pedaling, 60 ampere battery is charged fully and can provide 60 AH lightness when used with the voltage inverter circuit.

### BRIEF DESCRIPTION OF THE DRAWINGS

The accompanying drawings, which are incorporated into and constitute a part of this specification, illustrate one or more embodiments, and together with the detailed description, serve to explain the principles and implementations of the invention. In the drawings:

FIG. 1 is a block diagram illustrating the overall structure of the generator according to one embodiment of the present invention.

FIG. 2 is a block diagram showing an exemplary circuit according to one embodiment of the present invention.

### DETAILED DESCRIPTION OF THE PREFERRED EMBODIMENT(S)

This invention is directed to a generator 100, which can be utilize in two ways: (i) sourcing urgent electricity (Square Wave—220 and 12 V); and (ii) charging the automobile battery of a high voltage current.

In some embodiments, the power produced by the generator is in a voltage normal phase of 12 volt, loadless current of 55 Ampere, and overload phase of 30 Amp. Higher voltage is produced through applying the lower voltage, e.g., 12 volt, to a voltage inverter of 220 Volt

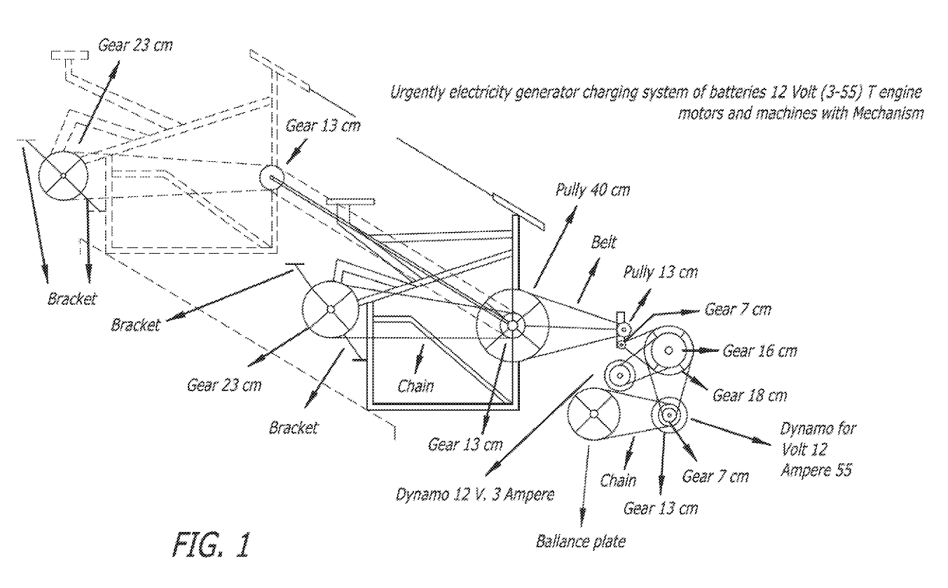

FIG. 1 is a block diagram illustrating the overall structure of the generator 100 according to one embodiment of the present invention. The generator 100 includes the following components: large gear 101, small gear 102, gear chain 103, bracket 104, pully 105, small pully 106, balancer plate 107, generator 12V/3 AH 108, 12V/3 Amp battery 109, and rectifier circuit 110. The rectifier circuit 110 comprises, for example, diode(s) and ripple-taker capacitor(s).

The generator 100 further includes: fuse 111 to protect the circuit, kinetic and starter lamp 112, 55 Amp generator dynamo 113, selector switch three-phases 114, luminous diode 115, 560 ohm resistance 116, double contact 12V relay 117, battery 118, belt 119, kinetic key 120, main dynamo starter 121, bobbin 122 for producing high voltage, automatic magnetic cutout 123.

The generator also includes tighter belt 124. Pressing by hand can replace the belt 124 without using any instrument.

In some embodiments, the generator 100 produces 55 Ampere in electricity.

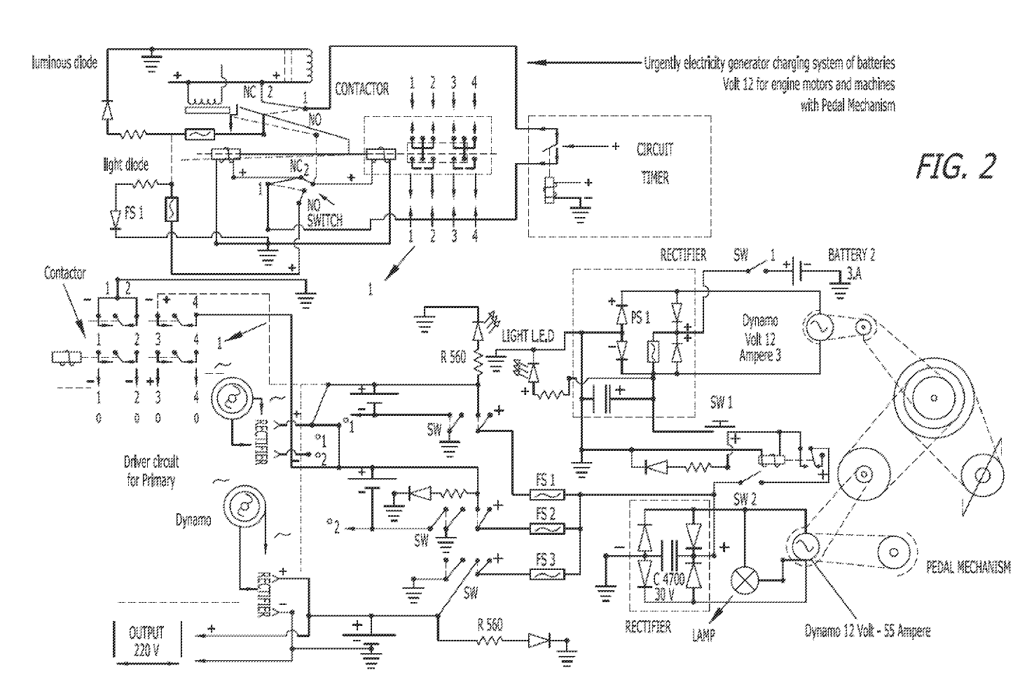

FIG. 2 is a block diagram showing an exemplary circuit 200 according to one embodiment of the present invention.

A lamped key 125 is used for kinetic and starting the main dynamo instead of start switch and the lamp behind the automobile's ampere. A chassis key 126 is provided in the generator 100. By pedaling and pressing the chassis key 126 for several seconds, the voltage of starter dynamo is supplied for starting the main dynamo and by cutting the press on the key. The dynamo voltage is applied to a 3A battery automatically for charging.

A starter relay 127 is provided for main dynamo (12v 30A) for determining the voltage path to the starter dynamo to the main dynamo is connected from the drive of this dynamo to the 3A dynamo.

A fuse panel 128 and fuse 129 are provided for protecting the circuits of charge path bobbins and returning the voltage.

A luminous emission diode or LED 130 is provided for displaying the voltage in the circuit and working the relative fuse.

Bobbins 131 are winded excessively due to specified circle of driver dynamo magnet with the circle.

Magnet 132 is provided for generating inductive field on the bobbins of the relative shaft.

A fan 133 is used at the minimum consumer ampere (140 m.m) for cooling the trance (high voltage).

Pedal bracket (stage) in the generator for reaching the ideal purpose is added to the length of the pedal bracket for applying pressure and comfortably of gears rotation, ⅓ to the main length.

Sharman (for tune-upping the gears chain) is devised in this design, against the bicycles structure that installed at the behind and under the gears, in the front and over the gear.

Metallic plate of 32 cm diameter that links to the end of head-dynamo gear though gear to the second gear uniaxial to the dynamo and the main role in making steady and un-circle the dynamo's rotation (without increasing the circle and speed). This sort of design is manufactured and designed for the first time to damp the rotational vibrations in the heavy gears of increasing speed.

What is claimed is:

1. A generator for pedaling, the generator comprising:
a frame comprising metallic parts;
a first belt; and
a box, wherein the generator receives concurrent pressure for starting a main dynamo.

2. The generator of claim 1, further comprising:
a screw;
a spanner; and
a springy tabular washer for connecting the accessories.

3. The generator of claim 1, further comprising:
a rubber vibration damper that prevents vibrating and impact.

4. The generator of claim 1, further comprising:
a 2-inch iron pipe with handles thereon for coupling and connecting the frame.

5. The generator of claim 1, further comprising:
a bicycle body;
two locking gears;
a pedal;
cycle chains;
a shaft; and
one or more pullies, wherein the shaft and the pullies connect the bicycle body and locking gears around the pedal axis with cycle chains.

6. The generator of claim 5, further comprising:
a third gear;
a balancer metallic plate; and
a ball bearing for facilitating transmission of rotational force from the third gear to the balancer metallic plate.

7. The generator of claim 6, further comprising:
a bearing with vibration damper for connecting the ball bearing to the frame and shaft.

8. The generator of claim 5, further comprising:
a wheel chain for connecting the gears in the generator.

9. The generator of claim 5, further comprising:
a main dynamo gear; wherein the gears transmit force from the pullies up to the vertex of the main dynamo gear.

10. The generator of claim 5, further comprising:
a rubber belt for connecting one of the pullies to the other.

11. The generator of claim 5, further comprising:
a second belt for tuning up and adjusting the first belt, wherein the second belt accompanies the ball bearing and vibration damper.

12. The generator of claim 5, further comprising:
a second shaft for connecting the pullies to each other and to the ball bearings.

13. The generator of claim 5, further comprising:
a blocking gear for facilitating the transmission of rotational movement.

14. The generator of claim 5, further comprising:
a pedal bracket.
